(19) United States
(12) Patent Application Publication
(10) Pub. No.: US 2023/0146779 A1
(43) Pub. Date: May 11, 2023

(54) Adaptive Measurement And Calculation Method for Luminescence Values of Chemiluminescence Analyzer

(71) Applicants: CHONGQING CAPITALBIO NEW VIEW DIAGNOSTIC TECHNOLOGY CO., LTD, Chongqing (CN); MIANYANG PEOPLE'S HOSPITAL, Mianyang, Sichuan (CN)

(72) Inventors: Guanbin ZHANG, Chongqing (CN); Huailin WANG, Chongqing (CN); Song ZHAO, Chongqing (CN); Jigang LIU, Chongqing (CN); Yun GAO, Chongqing (CN); Wei YIN, Chongqing (CN)

(21) Appl. No.: 17/755,313

(22) PCT Filed: Apr. 14, 2021
(86) PCT No.: PCT/CN2021/087122

§ 371 Date: Apr. 26, 2022

(30) Foreign Application Priority Data
Feb. 20, 2021 (CN) 202110190795.7

(51) Int. Cl. G01N 21/76; G06M 1/272

(52) U.S. Cl. CPC G01N 21/766; G06M 1/272

(57) ABSTRACT

An adaptive measurement and calculation method for luminescence values of a chemiluminescence analyzer is provided. A fixed step length is adopted for continuous multi-point reading to obtain a complete correspondence diagram of detection positions and luminescence values. Two nearest luminescence values on the left and right sides of a maximum value are selected, the nearest luminescence values on both sides are connected to form a straight line, and an intersection of two straight lines is taken as an approximate maximum luminescence value. The measurement and calculation method can adapt to random positions of the detected object, and stably obtain the approximate maximum luminescence value, thus reducing increased complex hardware design and cost to confirm accuracy of the measurement position.

### FIELD OF THE INVENTION

The present invention relates to the technical field of chemiluminescence immunoassay, in particular to an adaptive measurement and calculation method for luminescence values of a chemiluminescence analyzer.

### BACKGROUND OF THE INVENTION

In a chemiluminescence immunoanalyzer, when a photon counter is used to measure a luminescence value of a detected object, the method of measuring the luminescence value of the detected object at a fixed position is usually used. The fixed position is generally determined through calibration which aligns a center of the detected object with a center of a photon counter probe in order to obtain a maximum luminescence value with least loss.

The simplest measurement method is open-loop control. After the photon counter probe or the detected object moves from a reset position to a calibration position to measure the luminescence value. There is no feedback signal to correct the number of motion steps during the motion, and the measured position may deviate. Closed-loop control is more commonly used. On the basis of open-loop control, feedback signal input such as a code disk and an encoder, is added, so that the motion step before each measurement corrected, realizing the requirement of repeated position measurement.

As shown in FIG. 1, A is the detected object, specifically a compound liquid detection window generating luminescence, and B is the photon counter probe. A and B are constrained by mechanical parts, and there is no stray light around. The more concentric and close A and B are, the stronger the measured luminescence value is.

In an actual test process, the detected object needs to be replaced. After replacement, the position of the detected object is affected by a gap between and errors of a placement base and a detected object carrying container, and there is a certain deviation, so that the measured luminescence value is below the maximum luminescence value in each measurement. Since a stable offset cannot be achieved, the measured luminescence values are always distributed below the maximum luminescence value with an uncertain error. Such an offset cannot be corrected by the above calibration method.

Therefore, A will produce offset. Even if B can reset in place under control, the method of measuring the maximum luminescence value at the fixed position is theoretically impossible.

### SUMMARY OF THE INVENTION

In view of the above shortcomings in the prior art, the present invention provides an adaptive measurement and calculation method for luminescence values of a chemiluminescence analyzer, which solves the problem that a real maximum luminescence value cannot be measured or calculated.

In order to achieve the object, the present invention uses the following technical solution: an adaptive measurement and calculation method for luminescence values of a chemiluminescence analyzer, comprises the following steps:

S1. with a distance d as a step, starting from entry of a left edge point P4 of a photon counter probe B into a left edge point P1 of a detected object A and ending at exit of the left edge point P3 of the photon counter probe B from a right edge point P2 of the detected object A;

S2. collecting the luminescence value once when the photon counter probe moves every step d, and recording the luminescence value data into an F[i] array, wherein i is a measurement position, and F[i] is the luminescence value data of the measurement position i;

S3. finding a maximum value of the F[i] array and setting to F(X); and

S4. forming a straight line a with points F(X−2) and F(X−1), forming a straight line b with points F(X+2) and F(X+1), and taking an ordinate of an intersection Z of the straight line a and the straight line b as a maximum luminescence value.

Further, the F[i] array in step S2 has (W1+W2)/d luminescence value data, W1 is a distance from the point P1 to the point P2, and W2 is a distance from the point P3 to the point P4.

Further, the straight line formed by the point F(X−2) and the point F(X−1) in step S4 is y=k1*x+b1, k1 is a slope of the straight line a, and b1 is a y-axis intercept of the straight line a.

Further, the straight line formed by the point F(X+2) and the point F(X+1) in step S4 is y=k2*x+b2, k2 is a slope of the straight line b, and b2 is a y-axis intercept of the straight line b.

Further, the maximum luminescence value in step S4 is (b2−b1)*k1)/(k1−k2)+b1 or (b2−b1)*k2)/(k1−k2)+b2.

Further, the value of the step d is 1 mm.

Beneficial effects of the present invention are as follows: In the present invention, a fixed step length is adopted for continuous multi-point reading to obtain a complete correspondence diagram of detection positions and luminescence values. Two nearest luminescence values on the left and right sides of a maximum value are selected, the nearest luminescence values on both sides are connected to form a straight line, and an intersection of two straight lines is taken as an approximate maximum luminescence value.

The present invention relates to a measurement and calculation method which can adapt to random positions of the detected object, and stably obtain the approximate maximum luminescence value, thus reducing increased complex hardware design and cost to confirm accuracy of the measurement position. Deviation of the position of the detected object will not affect correspondence between the measurement position and the luminescence value, nor affect the maximum luminescence value and intensity of the nearby luminescence value.

### BRIEF DESCRIPTION OF THE DRAWINGS

FIG. 1 is a schematic diagram of relationship between a detected object A and a photon counter probe B;

FIG. 2 is a schematic diagram of a starting position of continuous luminescence value reading;

FIG. 3 is a schematic diagram of an end position of the continuous luminescence value reading;

FIG. 4 is a schematic diagram of a relationship between multi-point measurement positions of the detected object and luminescence values of corresponding positions;

FIG. 5 is a schematic diagram of a curve of the multi-point measurement positions of the detected object and the luminescence values of the corresponding positions;

FIG. 6 is a schematic diagram of a calculation method of an approximate maximum luminescence value;

FIG. 7 is a schematic diagram of a luminescence value detection mechanism for a chemiluminescence immunoanalyzer in the embodiment;

FIG. 8 is a schematic diagram of correlation between the measurement positions and the luminescence values in the embodiment; and

FIG. 9 is a schematic diagram of the calculation method of the approximate maximum luminescence value in the embodiment.

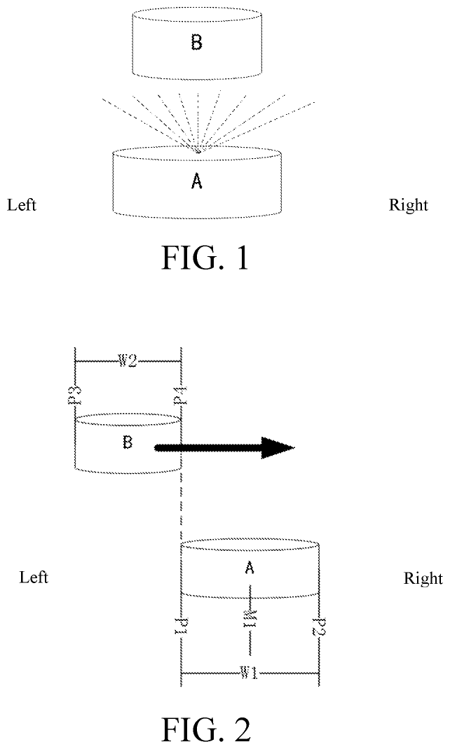

### DETAILED DESCRIPTION OF THE PREFERRED EMBODIMENTS

The specific embodiments of the present invention are described below to enable those skilled in the art to understand the present invention. However, it should be noted that the present invention is not limited to the scope of the specific embodiments. For persons of ordinary skill in the art, all inventions and creations that utilize the concept of the present invention are included in the protection provided that variations are within the spirit and scope of the present invention as defined and determined by the appended claims.

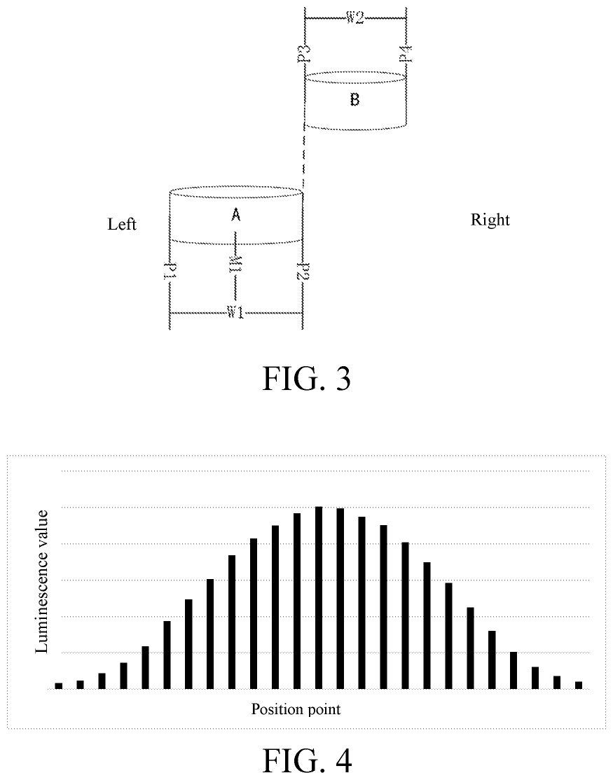

As shown in FIG. 2 and FIG. 3, a left edge of A is point P1, and a right edge thereof is point P2. A left edge of B is point P3, and a right edge thereof is point P4. A distance between the point P1 and the point P2 is W1, a distance between the point P3 and the point P4 is W2, and a center between the point P1 and the point P2 is M1.

With a distance d as a step, the photon counter probe B starts from entry of the point P4 of the photon counter probe B into the point P1 of the detected object A and ends at exit of the point P3 of the photon counter probe B from the point P2 of the detected object A. A luminescence value is collected once for each motion of the distance d. In a whole process, (W1+W2)/d luminescence value data are collected.

Recorded data are assigned to an F[i] array. With i as an X axis, that is, measurement positions, i=(W1+W2)/d, and F[i] as a Y axis, that is, luminescence values, a schematic diagram of a relationship between the multi-point measurement positions of the detected object and the luminescence values of the corresponding positions is formed, as shown in FIG. 4.

A maximum value is found from the F[i] array and set to F(X). Since the maximum luminescence value is generated when the detected object A is concentric with the photon counter probe B, when the detected object a is placed, the maximum luminescence value exists only when the photon counter probe B is moving and aligned with a center point of the detected object A. Only when the position point for collecting F(X) coincides with the concentric position point, F(X) is the maximum luminescence value. The photon counter probe B moves and measures in the step of distance d, it is difficult to coincide the position point for collecting F(X) with the concentric position point, and F(X) is less than the maximum luminescence value.

Since F(X) is already the maximum value in the luminescence values collected after motion, the position point for collecting the maximum luminescence value exists at a position between the position points for collecting F(X−1) luminescence value and the position points for collecting F(X+1) luminescence value. The collected position point is set as X′, the maximum luminescence value is F(X′).

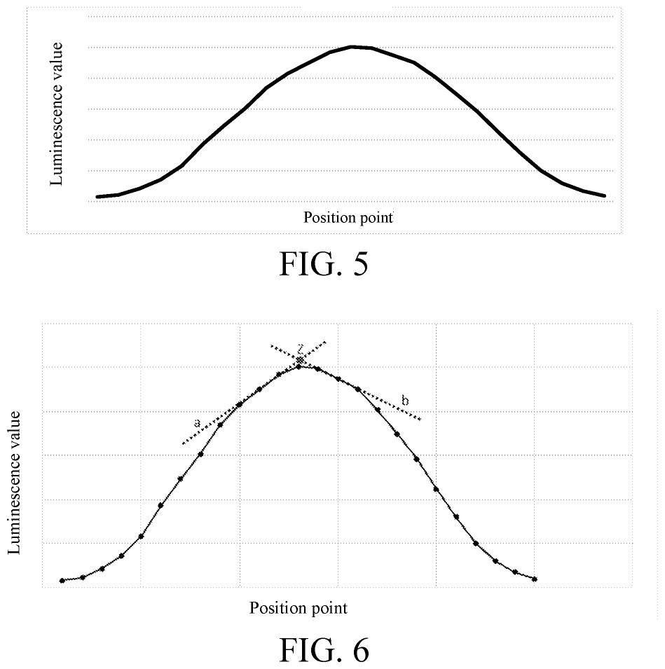

The F[i] values at the luminescence value sites in the chart are connected with line segments, F(x)=kx+b is set, as shown in FIG. 5.

When the distance d is small enough to enable the maximum luminescence value to be collected:
a. F(X′)=kX′*x+bX′, where kX′=0, bX′=current luminescence value=maximum luminescence value;
b. In F(X′−1), kX′−1>0, and lim(kX′−1)=0;
c. In F(X′+1), kX′+1<0, and lim(kX′+1)=0.
d. Similarly, in F(X′−2), kX′−2>kX′−1>0;
e. In F(X′+2), kX′+2<kX′+1<0.

It can be seen that the closer X is to the X′ position, the closer the slope kX corresponding to F(X) is to 0.

When the distance d is small enough, two points F(X′−2) and F(X′−1) are set to form a connecting line a′, and two points F(X′+2) and F(X′+1) are set to form a connecting line b′. a′ has a very small positive slope, b′ has a very small negative slope, and an intersection is the maximum luminescence value F(X′).

Two points F(X−2) and F(X−1) are set to form a connecting line a, two points F(X+2) and F(X+1) are set to form a connecting line b, and the two straight lines coincide at an intersection Z marked in red, as shown in FIG. 6. The intersection Z is greater than the maximum luminescence value F(X′), and difference depends on fineness of the value d: the smaller the value d, the smaller the difference; and the greater the value d, the greater the difference.

In the case of the certain step distance d, the connecting line a and connecting line b reflect luminescence properties on both sides of the maximum luminescence value of the detected object, and the properties are stable. A plurality of detected objects generated under the same reaction conditions have the same luminescence properties, and the calculated intersection Z value is stable, and can be used as the approximate maximum luminescence value.

Although the collected luminescence value F(X) is a real luminescence value directly collected, the value is uncertain and cannot be equivalent to or calculated and applied to the maximum luminescence value.

The straight line formed by two points F(X−2) and F(X−1) is set to be y=k1*x+b1, and the straight line formed by two points F(X+2) and F(X+1) is set to be y=k2*x+b2.

According to a simultaneous equation, an intersection of the two straight lines is ((b2−b1)/(k1−k2),(b2−b1)*k1)/(k1−k2)+b1) (or ((b2−b1)/(k1−k2),(b2−b1)*k2)/(k1−k2)+b2)), that is, the approximate maximum luminescence value is: (b2−b1)*k1)/(k1−k2)+b1 (or (b2−b1)*k2)/(k1−k2)+b2).

The embodiment of the present invention had the following steps:

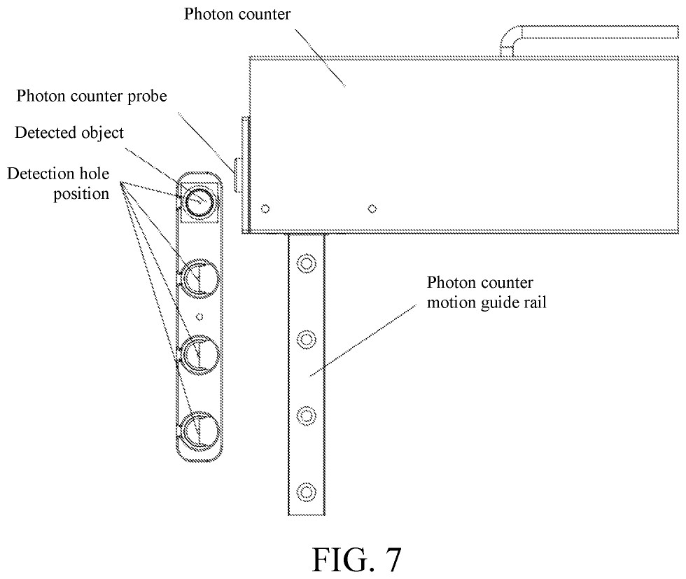

A chemiluminescence immunoanalyzer had a luminescence value detection mechanism as shown in the figure below. The photon counter could move back and forth in a motion rail of the photon counter to perform continuous multi-point reading on the detected object. The analyzer had four detection holes, and a certain detected object with high luminescence value was placed in the innermost detection hole, as shown in FIG. 7.

The photon counter was controlled to move in steps of 1 mm from the left edge of an opening edge of the detected channel, and the value was read once for each step. The luminescence values of 25 points were collected.

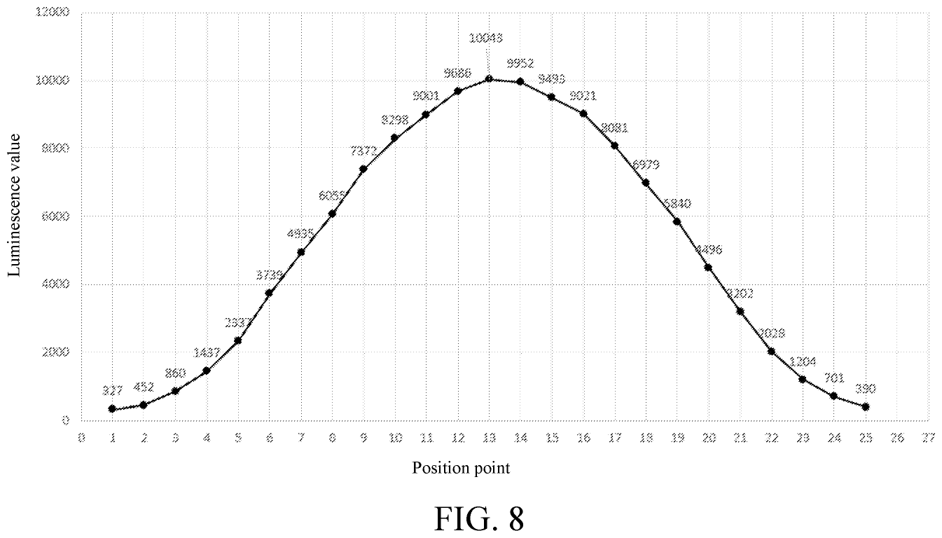

The collected data were stored in the F[x] array in the sequence of collection. The F[x] curve is shown in FIG. 8:

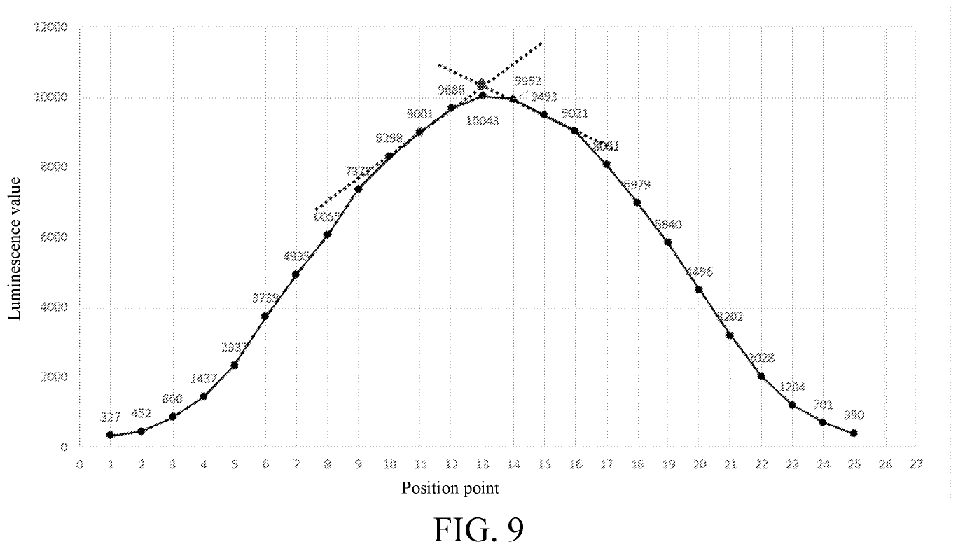

According to the calculation method of the real luminescence value, the maximum value of the data was F(13), and points F(12)=9686 and F(11)=9001 were substituted into y=k1*x+b1 to obtain k1=9686−9001=685, and b1=9686−685*12=1466; and points F(14)=9952 and F(15)=9493 were substituted into y=k2*x+b2 to obtain k2=9493−9952=−459, and b2=9952+459*14=16378. In this way, two straight lines were obtained, as shown in FIG. 9.

Finally, the luminescence value (b2−b1)*k2)/(k1−k2)+b2=((16378−1466)*(−459))/(685+459)+16378≈10394.95 is obtained.

After this measurement, the calculated approximate maximum luminescence value was 10395.

1. An adaptive measurement and calculation method for luminescence values of a chemiluminescence analyzer, wherein the method comprises the following steps:
S1. with a distance d as a step, starting from entry of a right edge point P4 of a photon counter probe B into a left edge point P1 of a detected object A and ending at exit of the left edge point P3 of the photon counter probe B from a right edge point P2 of the detected object A;
S2. collecting the luminescence value once when the photon counter probe moves every step d, and recording the luminescence value data into an F[i] array, wherein i is a measurement position, and F[i] is the luminescence value data of the measurement position i;
S3. finding a maximum value of the F[i] array and setting to F(X); and
S4. forming a straight line a with points F(X−2) and F(X−1), forming a straight line b with points F(X+2) and F(X+1), and taking an ordinate of an intersection Z of the straight line a and the straight line b as a maximum luminescence value.

2. The method according to claim 1, wherein the F[i] array in step S2 has (W1+W2)/d luminescence value data, W1 is a distance from the point P1 to the point P2, and W2 is a distance from the point P3 to the point P4.

3. The method according to claim 1, wherein the straight line formed by the point F(X−2) and the point F(X−1) in step S4 is y=k1*x+b1, k1 is a slope of the straight line a, and b1 is a y-axis intercept of the straight line a.

4. The method according to claim 3, wherein the straight line formed by the point F(X+2) and the point F(X+1) in step S4 is y=k2*x+b2, k2 is a slope of the straight line b, and b2 is a y-axis intercept of the straight line b.

5. The method according to claim 4, wherein the maximum luminescence value in step S4 is (b2−b1)*k1)/(k1−k2)+b1 or (b2−b1)*k2)/(k1−k2)+b2.

6. The method according to claim 1, wherein the value of the step d is 1 mm.
